(19) United States
(12) Patent Application Publication
(10) Pub. No.: US 2026/0154352 A1
(43) Pub. Date: Jun. 4, 2026

(54) PRIORITIZED SUMMARIZATION OF CONTENT ITEMS USING LANGUAGE MODEL NEURAL NETWORKS

(71) Applicant: Google LLC, Mountain View, CA (US)

(72) Inventors: Zhe Feng, Sunnyvale, CA (US); Aranyak Mehta, Palo Alto, CA (US); Kumar Avinava Dubey, Palo Alto, CA (US); Rahul Kidambi, Sunnyvale, CA (US); Di Wang, Sunnyvale, CA (US); Christopher Park Mah, Palo Alto, CA (US); Kshipra Uday Bhawalkar, Mountain View, CA (US); Christopher Vui Liaw, Mountain View, CA (US)

(21) Appl. No.: 19/281,303

(22) Filed: Jul. 25, 2025

Related U.S. Application Data
(60) Provisional application No. 63/676,247, filed on Jul. 26, 2024.

(51) Int. Cl. G06F 16/904

(52) U.S. Cl. CPC G06F 16/904

(57) ABSTRACT

Methods, systems, and apparatuses, including computer programs encoded on computer storage media, for generating a summary of a set of content items using a language model neural network. In particular, the described techniques include processing data characterizing a set of content items and the respective relative prominence data for each of the set of content items using a language model neural network to generate the summary of the set of content items. Because the relative prominence data is included in the input to the language model neural network, the summary will reflect the relative prominence represented for each of the content items.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates a summary of a set of content items using a language model neural network, e.g., a large language model neural network (LLM).

Particular embodiments of the subject matter described in this specification can be implemented so as to realize one or more of the following advantages.

Generating a summary of a set of content items (e.g., webpages, books, videos, news articles, and so on from sources like the internet, a library of books, a repository of videos, a repository of news articles, and so on) is important to efficiently make available the information contained in the content items. That is, summaries of respective sets of content items provide succinct information representing the content items and are computationally efficient for use with downstream tasks (e.g., require less computational memory or less computational processing). These summaries are computationally efficient because they reduce the size of data to be processed while also maintaining the important information present in the set of content items. For example, a natural language text summary that captures the main events presented in a set of news articles (i.e., a set of content items) is more computationally efficient to use in a downstream task such as a question-answering task than the set of content items and can be just as accurate as using the set of content items.

However, beyond just generating a summary of a set of content items, it is important to be able to generate the summary in accordance with respective target prominences for each of the set of content items. That is, because content items of the set can have different relevance to the summary (e.g., different importance, different interest to a user, different qualities, and so on), a summary that incorporates contents referencing the respective content items equally or randomly is a worse summary than one that includes contents referencing respective content items in accordance with desired prominence.

For example, a summary of user reviews of a product (i.e., a set of content items) where some user reviews are reliable, and others are not but all are equally represented as content in the summary can result in a summary that is unreliable. This unreliability is due to the presence of contents in the summary referencing the unreliable reviews being more prominent than desired, and the presence of contents in the summary referencing the reliable reviews being less prominent than desired.

This specification describes techniques that can address the aforementioned challenges by processing data characterizing a set of content items and respective relative prominence data for each of the set of content items using a language model neural network to generate the summary of the set of content items. Because the relative prominence data is included as part of the input to the language model neural network, the summary generated by the language model neural network will reflect the relative prominence represented for each of the content items. That is, the language model neural network generates a summary that faithfully reflects the respective relative prominence and essential information of the content items.

For example, the described techniques can generate a summary of user reviews (described in the above example) that is in accordance with respective prominence data for each of the user reviews (that reflects the desired prominence for the review, i.e., content in the review referencing reliable reviews has higher prominence than content referencing unreliable reviews) by using a language model neural network that processes data characterizing a set of content items and the respective relative prominence data for each of the set of content items to generate the summary of the set of content items.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows a summarization system.

FIG. 2 is a flow diagram of an example process for generating a summary of a set of content items.

FIG. 3 is an example of summaries of a first set of content items.

FIG. 4 is an example of the performance of the described techniques.

Like reference numbers and designations in the various drawings indicate like elements.

### DETAILED DESCRIPTION

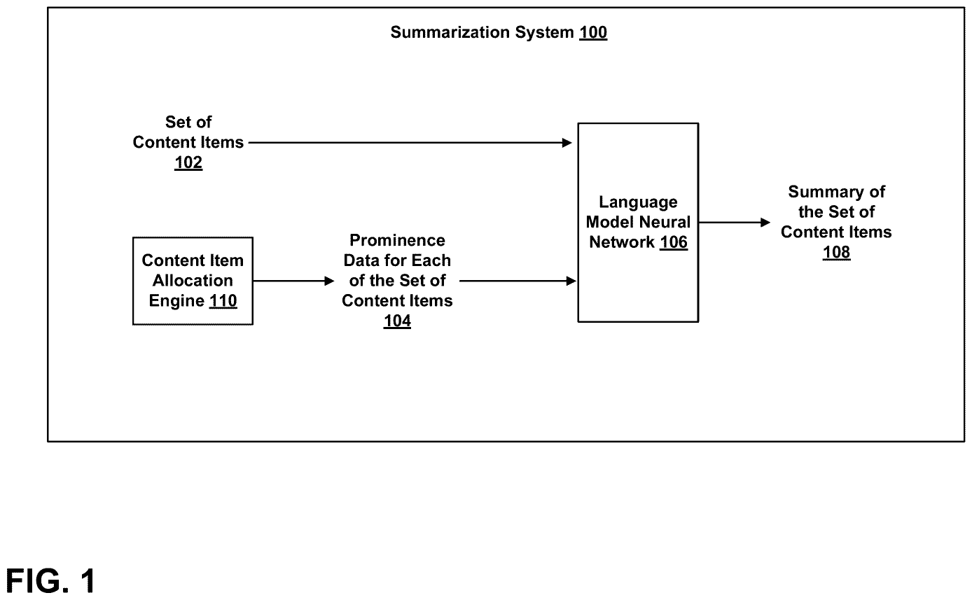

FIG. 1 shows a summarization system 100. The system 100 is an example of a system implemented as computer programs on one or more computers in one or more locations, in which the systems, components, and techniques described below can be implemented.

The summarization system 100 generates a summary of a set of content items 108 using a language model neural network 106, e.g., a large language model neural network (LLM).

For example, the system 100 can receive a set of content items 102 that have been determined to be relevant to a search query that has been received from a user and can provide the generated summary of the set of content items 108 for presentation to the user in response to the query, e.g., on a user device of the user.

More specifically, the system 100 also obtains respective prominence data for each of the set of content items 104 that represents, for each content item, a relative prominence of the content item in the summary of the set of content items 108.

The relative prominence of a given content item in the summary 108 characterizes a prominence of content referencing the given content item in the summary 108 relative to content referencing other content items in the set. That is, the relative prominence defines how prominent the content referencing the given content item is in the summary 108 relative to how prominent content referencing other content items in the set is in the summary 108.

Prominence can be determined in any of a variety of ways but generally measures how important the content is likely to be to a user viewing or otherwise interacting with the summary 108.

The system 100 then processes data characterizing the set of content items 102 and the respective relative prominence data for each of the set of content items 102 using the language model neural network 106 to generate the summary of the set of content items 108. Because the relative prominence data is included as part of the input to the language model neural network 106, the summary 108 generated by the language model neural network 106 will reflect the desired or “target” prominence represented by the prominence data 104. That is, rather than assign equal prominence or a random prominence or other arbitrary prominence to each content item in the summary 108, the language model neural network 106 instead generates a summary 108 that assigns different prominence to different content items in accordance with the prominence data 104.

The content items can be any appropriate type of content item, e.g., a video, an electronic book, a software application, a news article, a web page, a music content item, e.g., a song, a web page or other resource describing a product, an online advertisement, and so on.

To obtain the prominence data 104, the system 100 can receive or determine the prominence data 104 from any of a variety of sources.

For example, the system 100 can receive the prominence data 104 from a user of another system, e.g., another system that determines the relative importance of each of the content items.

As another example, the system 100 can determine the prominence data 104 using a content item allocation engine 110 based on any of a variety of factors, e.g., an objective for the allocation, the relative importance of each of the content items, the quality of each of the content items, the likelihood that the user will select or interact with a given content item if it is assigned a given prominence, and so on.

The content item allocation engine 110 can be implemented as one or more computer program(s), one or more hardware devices, or both on one or more computers in one or more locations that processes appropriate inputs to determine the prominence data 104. For example, if the allocation engine 110 determines the prominence data 104 based the quality of each of the content items in the set of content items 102, then the allocation engine can be one or more computer programs executed on one or more processors of the system 100 that receives the associated necessary inputs (e.g., a quality score for each content item of the set of content items 102) from the system 100 and determines the prominence data 104 (e.g., by applying an appropriate algorithm that requires the quality scores of the content items as input).

Examples of the operations performed by the content item allocation engine 110 to determine prominence data 104 will be described in more detail below.

The summary of the set of content items 108 includes respective content that is a succinct and informative for one or more of the set of content items and can have any modality (e.g., text, audio, image, video, or any combination of these).

For example, for a set of content items 108 that are news articles describing key events, the summary 108 can be a text summary of the key events, a text summary with inline images of the key events, a video summary animating the key events, an audio summary describing the key events, and so on.

The system 100 or another system can use the summary 108 for any of a variety of types of downstream tasks.

For example, the system 100 can generate the summary 108 as part of making a content item recommendation for the user.

For example, the prominence data for each of the set of content items 104 can reflect each content item's interest to a user (i.e., how suitable the content item is for recommendation to the user). In this way, the summary 108 acts as a content item recommendation for the user in that content items that are of potential interest to the user are proportionally represented as content in the summary 108.

As another example, after the system 100 generates the summary 108 with prominence data 104 in accordance with user interest in the content items as described above, the system can then further process the summary 108 (e.g., using a generative neural network) to select one content item to serve as a recommendation to the user (i.e., serve as a content item recommendation).

The system 100 can generate the content item recommendation in any appropriate context.

For example, the system 100 can generate content recommendations during a conversation between the user and one or more other entities, e.g., another user or a chatbot or both. For example, the system 100 can detect a user intent during a conversation and generate content recommendation based on the user intent. For example, after user statements such as, “Which restaurants near me offer pizza?”, “Which park is best to bring my dog to and has a playground?”, “Play relaxing music for me to drive to.”, the system can respectively generate a restaurant recommendation, park location recommendation, song recommendation.

As another example, the system 100 can generate content recommendations in response to search queries submitted by the user to a search engine, e.g., an Internet search engine that searches web pages on the Internet, an image search engine that searches a repository of images, a video search engine that searches a repository of videos, an app store search engine that searches a repository of software applications that are available for download, an electronic book store search engine that searches a repository of electronic books, and so on.

Generally, after the system 100 generates a recommendation of a given content item, the system 100 or another system presents the recommended content item to the user, e.g., on a user device of the user. For example, the system can provide the content item for presentation to a user or provide a search result that identifies the content item and that, when selected by a user, causes the content item to be presented with by the user.

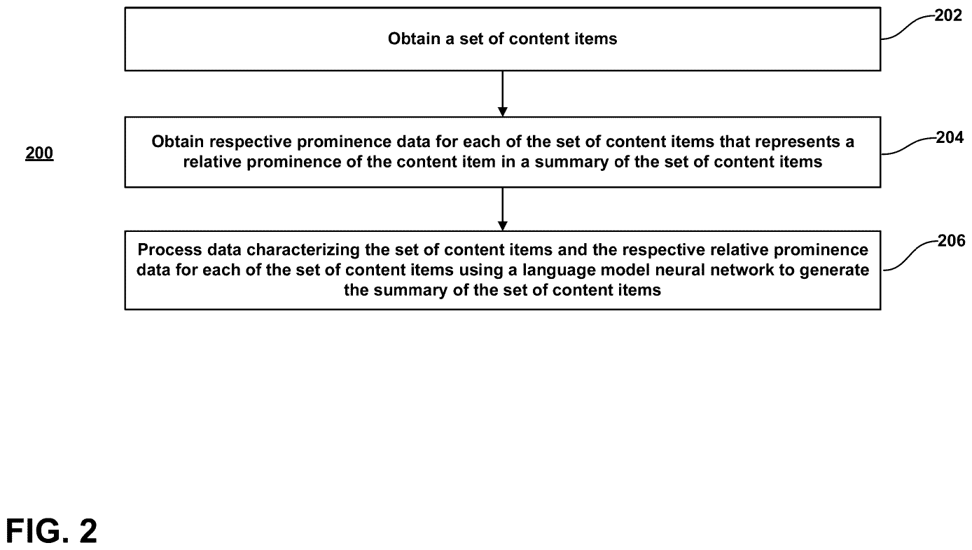

FIG. 2 is a flow diagram of an example process 200 for generating a summary of a set of content items. For convenience, the process 200 will be described as being performed by a system of one or more computers located in one or more locations. For example, a summarization system, e.g., the summarization system 100 of FIG. 1, appropriately programmed in accordance with this specification, can perform the process 200.

The system obtains a set of content items (step 202).

As described above, the content items can be any appropriate type of content items, e.g., a video, an electronic book, a software application, a news article, a web page, a music content item, e.g., a song, a web page or other resource describing a product, an online advertisement, and so on. More generally, the content items can have any appropriate modality, including text, audio, images, video, or any combination of these.

The system can obtain the set of content items from any of a variety of sources.

For example, the system can obtain the set of content items from system-maintained data. As another example, the system can obtain the set of content items from a user of another system through any of a variety of methods, e.g., using a network connection, e.g., a cloud-based network, the internet, or a local network.

In some cases, the set of content items are content items that have been determined to be relevant to a query received from a user. That is, in response to a query received from a user, the system determines and obtains a set of content items relevant to the query.

The query can be an appropriate type of query and have any appropriate type of modality (e.g., text, image, audio, video, or any combination of theses).

In some cases, the system uses another system to determine and obtain the set of content items relevant to the query.

For example, the query can include natural language text that the system receives from the user and submits to a website search engine, and the set of content items can be websites on the internet that the website search engine returns to the system and determines to be most relevant to the query. The websites can contain text, image, audio, video or any combination of these modalities.

As another example, the search query can include an image, natural language text, or a combination of both that the system receives from the user and submits to an image search engine, and the set of content items can be the images that the image search engine returns to the system and determines are most relevant to the query.

As another example, the search query can include audio that the system receives from the user and submits to a music search engine, and the set of content items can be the audio clips of different songs that the music search engine returns to the system and determines are most relevant to the query.

As another example, the query can be natural language text representing keywords associated with digital files on a computer that the system receives from the user and submits to the computer's operating system, and the set of content items can be the relevant digital files associated with the query determined by the computer's operating system and returned to the system. The digital files can contain text, image, audio, video or any combination of these modalities.

The system obtains respective prominence data for each of the set of content items that represents a relative prominence of the content item in a summary of the set of content items (step 204). The relative prominence of the content item in the summary characterizes a prominence of content referencing the content item in the summary relative to content referencing other content items in the set. As described above, the prominence generally measures how important the content is likely to be to a user viewing or otherwise interacting with the summary, but the prominence can be based on any appropriate one or more components.

Generally, the prominence data for each of the set of content items can be any type of appropriate data that can determine relative prominence in the summary. For example, the prominence data can include a score (e.g., a higher score corresponds to higher prominence), a ranking (i.e., a higher ranking corresponds to higher prominence), a natural language description (e.g., descriptions that characterize higher or lower prominence), and so on. Further details are described below.

In some implementations, the prominence of the content referencing the content item is based on one or more of the following three components.

The first component is based on an order of the content referencing the content item within the summary relative to content referencing other content items. The order of the content of the first component can refer to spatial ordering. For example, the spatial ordering can be top-to-bottom, left-to-right in a summary that includes text and inline images, where the top left of the summary corresponds to the first position in the order and the bottom right corresponds to the last position. The order of the content of the first component can also refer to temporal ordering.

For example, the temporal ordering can be the earlier or later presentation of content in a summary presented as video or audio playback.

The second component is based on an amount of content referencing the content item relative to the content referencing the other content item. The amount of the content of the second component can refer to a quantity or fraction of the summary. For example, the amount of content can refer to a quantity of letters, words, or lines in a text summary, and the fraction of letters, words, or lines in a text summary. As another example, the amount of content can refer to total or fraction of playback time of audio or video within an audio or video summary that has a fixed total playback time.

The third component is based on features of the content referencing the content item when the summary is presented to a user. The features of the content generally refer to any appropriate quality (e.g., attractive, humorous, formal, casual, emotional, and so on) for the content. For example, the feature of content may be humorous and therefore cause users to laugh out loud, e.g., a humorous video clip or amusing to read natural language text.

In some implementations, the respective prominence data for each of the set of content items includes a ranking of the set of content items. That is, the prominence data includes a ranking for each content item in the set, where the ranking for each content item in the set is determined by its position relative to all other content items in the set.

For example, the prominence data for each of the set of content items that includes three content items can include a first, second, or third ranking for each content item. For this example, a higher ranking corresponds to a higher prominence, so relative prominence is established through the rankings. Furthermore, when prominence is based on, e.g., ordering of content in the summary, these rankings can characterize the prominence of content referencing the content item in the summary. For example, when earlier positions in the summary correspond to higher prominence, the first ranked content item will have its content in the summary in the earliest position, the second ranked content item will have its content in the summary in the second earliest position, and the third ranked content item will have its content in the summary in the last position.

In some implementations, the respective prominence data for each of the set of content items includes a respective prominence score for each of the set of content items. For example, the prominence score can be represented as a positive real number within the interval of [0,1] or [0, ∞]. For these examples, a higher prominence score corresponds to higher prominence.

For example, the prominence data for each of the set of content items that includes three content items can include prominence scores that belong to the interval [0, ∞] such as the prominence scores [2.0, 1.0, 0.1]. For this example, a higher prominence score corresponds to a higher prominence, so relative prominence is established through the prominence scores. To have “normalized relative prominence” the system can apply the softmax function to the prominence scores and determine the relative prominence as fraction of 1 (i.e., softmax ([2.0,1.0,0.1])=[0.658, 0.242, 0.099]). Furthermore, when prominence is based on, e.g., amount of content in the summary, these normalized prominence scores can characterize the prominence of content referencing the content item in the summary. For example, when greater amount of content in the summary correspond to higher prominence and the summary has fixed total number of words, the highest scoring content item (i.e., prominence score of 2.0 or normalized prominence score of 0.658) will have its content in the summary utilize ˜65.8% of the words in the summary, the second highest scoring content item (i.e., prominence score of 1.0 or normalized prominence score of 0.242) will have its content in the summary utilize ˜24.2% of the words in the summary, and the third highest scoring content item (i.e., prominence score of 0.1 or normalized prominence score of 0.099%) will have its content in the summary utilize ˜9.9% of the words in the summary.

As described above, the system can receive the prominence data from a user of another system, e.g., another system that determines the relative importance of each of the content items.

In some implementations, the respective prominence data for the content items is determined by a content item allocation engine. As described above, the prominence data can be determined by the content item allocation engine based on any of a variety of factors, e.g., an objective for the allocation, the relative importance of each of the content items, the quality of each of the content items, the likelihood that the user will select or interact with a given content item if it is assigned a given prominence, and so on.

For example, for content items that are written reviews of a product where each review is generated by an author with a respective reviewer quality score (i.e., a score that represents how reliable the reviews generated by that author are on average), the content item allocation engine can determine the prominence data for each review based on the quality scores of the respective authors. For example, the content item allocation engine can assign a prominence score to each review that is proportional to the author's quality score.

As another example, for content items that are each online content relevant to a query from a user (e.g., advertisements, videos, images, text articles, E-books, websites, or software applications relevant to an appropriate user search engine query), the content item allocation engine can determine the prominence data for each online content (e.g., prominence score and/or ranking) based on an objective that measures aggregate value. The aggregate value can be based on: 1) likelihoods (determined from likelihood scores) that a user will interact with the online content once the summary is presented to the user, and 2) values of the online content to the system. The content item allocation engine can determine the prominence data for each online content that will maximize the aggregate value.

For example, the equation

$$aggregate value := {\sum }_{i} {L}_{i} ( {prom}_{i} ) \cdot {v}_{i}$$

represents how the content item allocation engine can determine aggregate value. The index i is over all content items, the term promᵢ represents the prominence data for content item i, the term Lᵢ(promᵢ) represents the likelihood that a user will interact with the content item i (which here is based on the prominence data associated with the content item), and the term vi is the value to the system content item i has. So, because the content item allocation engine can determine an aggregate value for assigned prominence data for each content item, the content item allocation engine can determine the assigned prominence data for each content item to maximize the aggregate value.

In some implementations, to generate a likelihood score that represents a likelihood that a user will interact with the content item once the summary is presented to the user for each of the set of content items, the system uses a selection prediction neural network. That is, for each of the set of content items, the system processes a first input that includes the respective prominence data for the content item using a selection prediction neural network to generate a likelihood score that represents a likelihood that a user will interact with the content item once the summary is presented to the user.

Thus, in some implementations, the system uses the content item allocation engine in conjunction with the selection prediction neural network. For example, the system can use the content item allocation engine that optimizes an objective in conjunction with the selection prediction neural network when the objective includes the likelihood that the user will select or interact with a given content item if it is assigned a given prominence. For example, the above described example of maximizing aggregate value associated with online contents.

In some cases, the first input further includes data characterizing the content item, i.e., any data associated with the content item. For example, if the content item is a text review of a product with an associated prominence data that is a real number prominence score, the first input can include the text content of the review, metadata of the review (e.g., the date it was written, the author, and so on), and the prominence score, which the selection prediction neural network processes to generate a likelihood score.

The selection prediction neural network can have any of a variety of neural network architectures. That is, the selection prediction neural network can have any appropriate architecture in any appropriate configuration that can process the first input to generate the likelihood score, including fully connected layers, convolutional layers, recurrent layers, attention-based layers, and so on, as is appropriate.

For example, the selection prediction neural network can have a transformer based architecture for processing a first input that is represented as a sequence (e.g., text content of a review followed by metadata of the review and a prominence score described in the above example) and an output layer that includes a sigmoid activation function to generate a likelihood of the user interacting with the content item between 0 and 1 (i.e., a likelihood score). Further details of the selection prediction neural network are described below.

The system processes data characterizing the set of content items and the respective relative prominence data for each of the set of content items using a language model neural network to generate the summary of the set of content items (step 206).

The data characterizing the set of content items can be any data associated with each of the content items.

For example, for a content item that is a news article, the data characterizing the news article can include the text representing the new article, the date the new article was written, the author of the new article, the website the news article is published on, and so on.

As another example, for a content item that is a video from an online video sharing platform, the data characterizing the video can include the video frames of the video, accompany audio clips to the video frames, the video's title, the video's description, the video's creator, the video's upload date, the number of times the video has been played by viewers on the internet, etc.

Therefore, the data characterizing the set of content items and the respective relative prominence data for each of the set of content items can have any modality (e.g., text, audio, image, video, or any combination of these) and represents an input (i.e., a multi-modal input) for the language model neural network. This input can also include natural language text instructions that guide the language model neural network (described in more detail below) to generate a summary based on both the data characterizing the set of content items and according to the respective relative prominence data for each of the set of content items.

As described above, the summary of the set of content items 108 includes respective content that is a succinct and informative for one or more of the set of content items and can have any modality (e.g., text, audio, image, video, or any combination of these). Therefore, the summary can be represented as a multi-modal output of the language model.

For example, for a set of content items that are books, the summary can be text describing the books, text along with images describing the books, video clips describing the books, natural speech description of the books, and so on.

As another example, for a set of content items that are songs, the summary can be text describing the songs' melodic characteristics.

As another example, for a set of content items that are videos, the summary can be text describing the videos, video clips overviewing the videos, and so on.

The language model neural network can have any of a variety of neural network architectures. That is, the language model neural network can have any appropriate architecture in any appropriate configuration that can process a multi-modal input and generate a multi-modal output that represents a summary, including fully connected layers, convolutional layers, recurrent layers, attention-based layers, and so on, as is appropriate.

Generally, the system can process video, image, text, and audio data of an input to the language model neural network by first processing the data of the input using appropriate feature encoders to generate features (i.e., embeddings) that are then further processed using the language model neural network.

For example, for a language model neural network input that includes natural language text, the system can map each character, word, or sub-word of the natural language text representation to a corresponding token by applying a text tokenizer to the input text. For example, the system can apply the Byte-Pair Encoding (BPE), WordPiece, or SentencePiece tokenizers to divide the natural language text data into tokens from a vocabulary. The system can then process the token sequence with a feature encoder neural network that is a text encoder (e.g., word2vec, GloVe, or BERT) to generate a sequence of features.

As another example, for a language model neural network input that includes an audio signal (e.g., audio clip), the system can convert an audio signal into a spectrogram and map segments (i.e., frequency, time patches of the spectrogram) to corresponding tokens and apply a feature encoder neural network that is an audio encoder neural network, e.g., using w2v-BERT model as described in arXiv:2108.06209, to obtain features for each map segment token.

As another example, for a language model neural network input that includes an image, the system can divide the image into blocks. Then the system can map each block to a corresponding token, e.g., by projecting each block into a token embedding. Then, the system can use a feature encoder neural network that is an image encoder, e.g., using the pre-trained Align encoder (as described in arXiv:2102.05918) or the pre-trained CoCa encoder (as described in arXiv:2205.01917) to process the tokens to generate respective features.

As another example, for a language model neural network input that includes video frames, the system processes each video frame as an image and obtains a respective feature for each image as described above.

As another example, for a language model neural network input that includes a video, the system can divide the video into a sequence of video frames and divide each video frame into patches and map each patch to a corresponding token. Alternatively, a token can represent a spatio-temporal portion of the video, i.e., a spatial portion of a group of video frames. The system can then use a feature encoder neural network that is a video encoder neural network, e.g., use the ViViT encoder as described in arXiv:2103.15691, to process the tokens and generate a respective feature for each token. Then, for each video frame (or group of video frames), the system can attention pool the features associated with the corresponding tokens of the video frame (or group of video frames) to obtain a feature for the video frame (or group of video frames).

In some cases, the language model neural network is a pre-trained neural network (i.e., the system or another system has previously determined the values of the trainable parameters of neural network through training on large data sets for one or more general tasks, e.g., next token prediction, image captioning, text-image alignment, and so on).

In some cases, the language model neural network processes a sequence of tokens to generate, as output, a sequence of tokens from a vocabulary, and the tokens can represent any modality of data such as text, image, audio, video and so on. For example, the language model neural network can be one that belongs to the Gemini family of neural networks, the Gemma family of neural networks, the PaliGemma family of neural networks, and so on.

As a particular example, when the input to the language model neural network includes video frames, corresponding audio clips, and natural language text instructions, the system can use the Gemini 1.5 Pro multi-modal neural network to process the input, e.g., process the video frames (using an image encoder as described above), the audio clips (using an audio encoder as described above), and instructions (using a text encoder as described above), to generate an output sequence that represents the summary.

In some situations, the language model neural network can be referred to as an auto-regressive neural network when the language model neural network auto-regressively generates an output sequence of tokens. More specifically, the auto-regressively generated output is created by generating each particular token in the output sequence conditioned on a current input sequence that includes any tokens that precede the particular token in the output sequence, e.g., the tokens that have already been generated for any previous positions in the output sequence that precede the particular position of the particular token.

For example, the language model neural network can be an auto-regressive Transformer-based neural network that includes (i) a plurality of attention blocks that each apply a self-attention operation and (ii) an output subnetwork that processes an output of the last attention block to generate the score distribution.

In this example, the language model neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

In some cases, the multi-modal input for the language model neural network incorporates one or more prompting techniques (e.g., zero-shot prompting, few-shot prompting, chain-of-thought prompting, role prompting, instruction prompting, rewriting or refining prompts, output constraints, self-consistency prompting, tool-use prompting, contextual priming, and so on). Such prompting techniques can help ensure that the language model neural network generates a summary that is in accordance with the prominence data for each of the set of content items. The prompting techniques can be particularly useful as natural language text instructions that guide the language model neural network to generate a summary based on both the data characterizing the set of content items and according to the respective relative prominence data for each of the set of content items.

In some implementations, the selection prediction neural network and the language model neural network have a shared embedding layer.

For example, for input that is data that characterizes a content item that is a news article and includes the text of the news article, both the selection prediction neural network and the language model neural network can process this input. That is, the selection prediction neural network can process this input as part of a first input to generate a likelihood that a user will interact with the content item once the summary is presented to the user; and the language model neural network can process this input as part of a multi-modal input (i.e., data characterizing the set of content items and the respective relative prominence data for each of the set of content items) to generate a summary. For both the neural networks, the system tokenizes the text of the news article (e.g., as described above, e.g., using BPE, WordPiece, SentencePiece, etc.) and then processes the text tokens using the same embedding layer to generate the same sequence of features (i.e., embeddings).

In some implementations, the selection prediction neural network and the language model neural network have one or more shared embedding layers.

For example, the selection prediction neural network can have any of the example architectures described above with respect to the first language model neural network, except the selection prediction neural network incorporates an output layer, such as a sigmoid layer, for the generation of a likelihood score of the user interacting with the content item.

In some implementations, when the set of content items are content items that have been determined to be relevant to a query received from a user, the system provides the summary of the set of content items for presentation to the user in response to the query, e.g., on a user device of the user.

For example, when the set of content items are websites relevant to a user query submitted to a search engine, the system can provide the text summary of the websites for presentation to the user on a display of the user's device (e.g., smartphone, laptop, or tablet).

As another example, when the set of content items are videos relevant to a user query submitted to a search video repository, the system can provide a summary of the videos (e.g., a text summary or a video summary) for presentation to the user on a display of the user's device (e.g., smartphone, laptop, or tablet).

In some implementations, when the system provides the summary of the set of content items for presentation to the user in response to the query, the system enables the user to interact with the referenced content items in the summary. That is, after the system presents the summary, the user can interact with referenced content items of the summary. For example, after presenting a summary of websites, the user can click a link to the landing page of the website. As another example, after presenting a summary of software applications, a user can select an application, initiating its download and installation on the device. As another example, after presenting a summary of e-commerce products, a user can select the product to view details of the product (e.g., price, description, etc.).

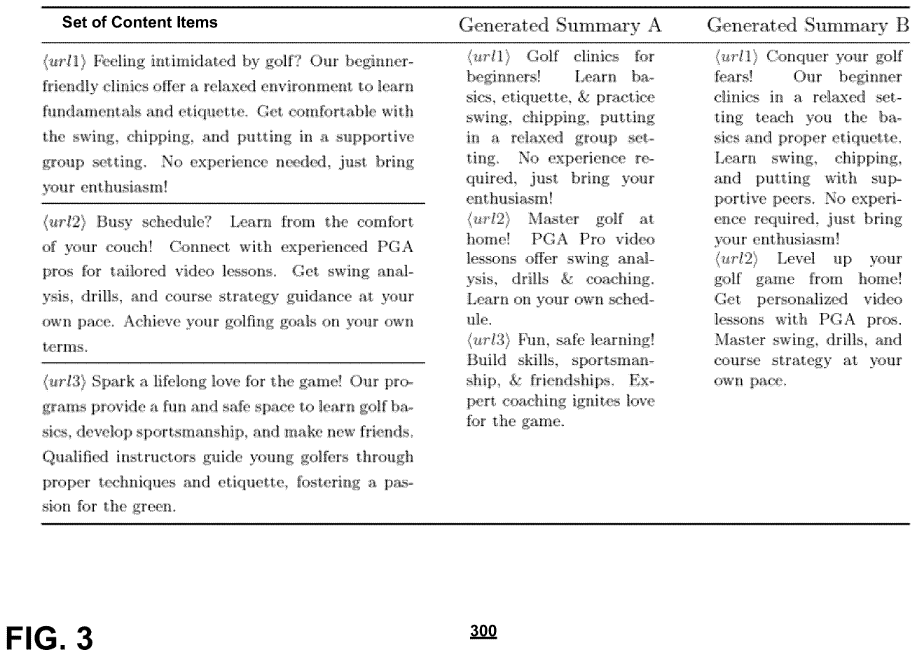

FIG. 3 is an example 300 of summaries of a set of content items.

In particular, example 300 shows a table with a column labeled “set of content items” that shows that the set of content items includes three different online text advertisements along with associated websites (indicated as <url1>, <url2>, <url3>) in response to a user query “learning golf”. Example 300 also has a column labeled “Generated summary A” that shows a summary of the content items for particular prominence data, and a column labeled “Generated summary B” that shows a summary of the content items for different prominence data than that used to generate “summary A”.

For example 300, the respective prominence data for each of the set of content items includes a ranking and prominence score for each of the set of content items, which are determined using a content item allocation engine that maximizes expected welfare, where welfare is computed using likelihoods of user interaction with the content items (i.e., likelihood the user clicks the URL associated with a content item determined using a selection prediction neural network) and advertisement owner bidding (i.e., how much an advertiser will pay per click on their advertisement's URL). The prominence of the content referencing the content item is based on two components: order of content (i.e., first, second, or third position in the summary) and amount of content (i.e., number of words in the summary with a fixed size of sixty words).

The prominence data used to generate summary A differs from that used to generate summary B in that the bidder values and selection prediction neural network used to determine the prominence data differ for these two summaries.

The “Generated Summary A” corresponds to prominence data for the three advertisements where the top, middle, and bottom advertisements in the column labeled “first content items” respectively are ranked 1, 2, 3 and have prominence scores 0.417, 0.333, 0.250. As a result, the prominence of the content in the summary referencing the top, middle, and bottom advertisements are respectively a first position with 25 words, a second position with 20 words, and a third position with 15 words.

The “Generated Summary B” corresponds to prominence data for the three advertisements where the top, middle, and bottom advertisements in the column labeled “first content items” respectively are ranked 1, 2, 3 and have prominence scores 0.583, 0.409, 0.007. As a result, the prominence of the content in the summary referencing the top, middle, and bottom advertisements are respectively a first position with 35 words, a second position with 25 words, and a third position with 0 words.

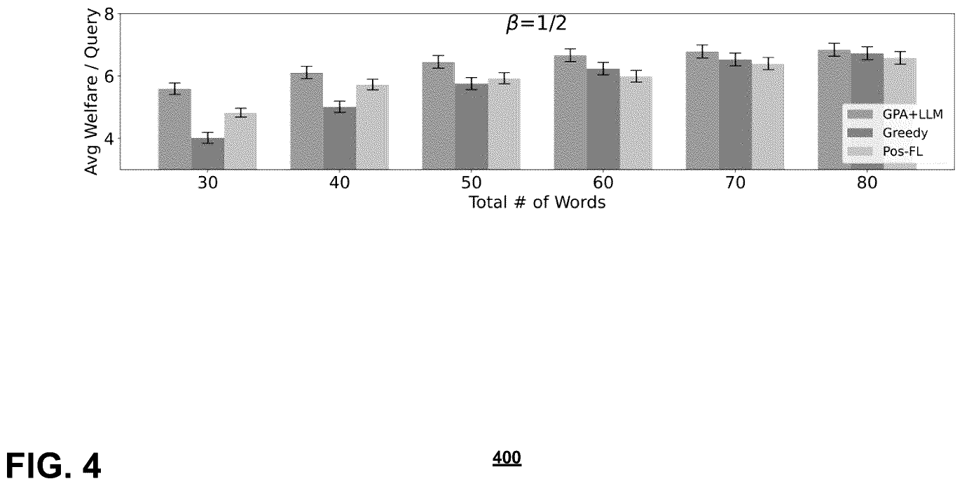

FIG. 4 is an example 400 of the performance of the described techniques.

In particular, example 400 shows the performance of the described techniques (i.e., the column bars labeled “GPA+LLM”) compared to other techniques (i.e., column bars labeled “Greedy” and “Pos-FL”) in terms of the metric “Avg Welfare” (i.e., expected welfare, as described in example 300) for summaries of various fixed sizes (i.e., 30, 40, 50, 60, 70, 80 words indicated on the x-axis).

The technique referred to as “Greedy” is a technique that does not utilize a language model to generate the summary but instead presents advertisements in the order of highest to lowest respective product values that are computed as the bid values for the advertisement multiplied by the respective likelihood that the user will interact with the advertisement once presented to the user.

The technique referred to as “Pos-FL” is a technique that does not utilize a content item allocation engine to determine the prominence data but instead sets the prominence of the contents referencing the content items in the summary to all have the same prominence (i.e., word count).

Example 400 shows that the described techniques always outperform the other techniques. The described techniques' use of a language model to generate the summary improve the expected welfare (as can be seen by “GPA+LLM” always outperforming “Greedy”); and the described techniques' use of content item allocation engine also improve the expected welfare (as can be seen by “GPA+LLM” always outperforming “Pos-FL”).

Example 400 shows that the difference in performance between the described techniques and the other techniques shrinks as the total number of words for the summary increases. The shrinking of the difference is due to the larger summary sizes being able to accommodate more of the content items.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a first set of content items;
obtaining respective prominence data for each of the first set of content items that represents a relative prominence of the content item in a summary of the first set of content items, wherein the relative prominence of the content item in the summary characterizes a prominence of content referencing the content item in the summary relative to content referencing other content items in the first set; and
processing data characterizing the first set of content items and the respective relative prominence data for each of the first set of content items using a language model neural network to generate the summary of the first set of content items.

2. The method of claim 1, wherein the first set of content items are content items that have been determined to be relevant to a query received from a user.

3. The method of claim 2, further comprising:
providing the summary of the first set of content items for presentation to the user in response to the query.

4. The method of claim 1, wherein the prominence of the content referencing the content item is based on one or more of:
an order of the content referencing the content item within the summary relative to content referencing other content items;
an amount of content referencing the content item relative to the content referencing the other content item; or
features of the content referencing the content item when the summary is presented to a user.

5. The method of claim 1, wherein the respective prominence data for each of the first set of content items comprises a ranking of the first set of content items.

6. The method of claim 1, wherein the respective prominence data for each of the first set of content items comprises a respective prominence score for each of the first set of content items.

7. The method of claim 1, further comprising:
for each of the first set of content items, processing a first input comprising the respective prominence data for the content item using a selection prediction neural network to generate a likelihood score that represents a likelihood that a user will interact with the content item once the summary is presented to the user.

8. The method of claim 7, wherein the selection prediction neural network and the language model neural network have a shared embedding layer.

9. The method of claim 1, wherein the respective prominence data for the content items is determined by a content item allocation engine.

10. A system comprising one or more computers and one or more storage devices storing instructions that when executed by the one or more computers cause the one more computers to perform operations, the operations comprising:
obtaining a first set of content items;
obtaining respective prominence data for each of the first set of content items that represents a relative prominence of the content item in a summary of the first set of content items, wherein the relative prominence of the content item in the summary characterizes a prominence of content referencing the content item in the summary relative to content referencing other content items in the first set; and
processing data characterizing the first set of content items and the respective relative prominence data for each of the first set of content items using a language model neural network to generate the summary of the first set of content items.

11. The system of claim 10, wherein the first set of content items are content items that have been determined to be relevant to a query received from a user.

12. The system of claim 11, the operations further comprising:
providing the summary of the first set of content items for presentation to the user in response to the query.

13. The system of claim 10, wherein the prominence of the content referencing the content item is based on one or more of:
an order of the content referencing the content item within the summary relative to content referencing other content items;
an amount of content referencing the content item relative to the content referencing the other content item; or
features of the content referencing the content item when the summary is presented to a user.

14. The system of claim 10, wherein the respective prominence data for each of the first set of content items comprises a ranking of the first set of content items.

15. The system of claim 10, wherein the respective prominence data for each of the first set of content items comprises a respective prominence score for each of the first set of content items.

16. The system of claim 10, the operations further comprising:
for each of the first set of content items, processing a first input comprising the respective prominence data for the content item using a selection prediction neural network to generate a likelihood score that represents a likelihood that a user will interact with the content item once the summary is presented to the user.

17. The system of claim 16, wherein the selection prediction neural network and the language model neural network have a shared embedding layer.

18. The system of claim 10, wherein the respective prominence data for the content items is determined by a content item allocation engine.

19. One or more non-transitory computer storage media storing instructions that when executed by one or more computers cause the one more computers to perform operations, the operations comprising:
obtaining a first set of content items;
obtaining respective prominence data for each of the first set of content items that represents a relative prominence of the content item in a summary of the first set of content items, wherein the relative prominence of the content item in the summary characterizes a prominence of content referencing the content item in the summary relative to content referencing other content items in the first set; and
processing data characterizing the first set of content items and the respective relative prominence data for each of the first set of content items using a language model neural network to generate the summary of the first set of content items.

20. The non-transitory computer storage media of claim 19, wherein the first set of content items are content items that have been determined to be relevant to a query received from a user.
